(19) United States
(12) Patent Application Publication
(10) Pub. No.: US 2023/0311199 A1
(43) Pub. Date: Oct. 5, 2023

(54) CASTING MOLD

(71) Applicant: GENERAL ELECTRIC COMPANY, Schenectady, NY (US)

(72) Inventors: Evin Nathaniel Barber, Logan, UT (US); Joshua L. Miller, West Chester, OH (US); Christophe Jude Day, Liberty Township, OH (US); Brian D. Przeslawski, Dayton, OH (US); Tingfan Pang, West Chester, OH (US); Gregory Terrence Garay, West Chester, OH (US); Xi Yang, Liberty Township, OH (US); Meredith Elissa Dubelman, West Chester, OH (US); Daniel Endecott Osgood, Loveland, OH (US); Ricardo Caraballo, Maineville, OH (US); Thomas Hewitt, Beavercreek, OH (US)

(21) Appl. No.: 17/713,540

(22) Filed: Apr. 5, 2022

(51) Int. Cl. B22C 7/02; B22C 9/10; B33Y 80/00

(52) U.S. Cl. CPC B22C 7/02; B33Y 80/00; B22C 9/10

(57) ABSTRACT

An intermediate investment casting mold includes at least a shell and a core. The shell has an outer surface and an inner surface, with the inner surface defining an interior for the shell. The core is located in the interior of the shell and is at least partially spaced from the inner surface of the shell. A void can be defined as the space between the core and the inner surface. The intermediate investment casting mold can include a plurality of anchors.

### TECHNICAL FIELD

The disclosure generally relates to a casting mold having a core and shell, more specifically a casting mold having an additively manufactured core and shell.

### BACKGROUND

A cast component can be formed by investment casting molding using a ceramic core-shell mold. The ceramic core-shell mold includes at least a core and a shell, with at least one cavity between the core and the shell. The core-shell mold can be manufactured using an additive manufacturing process. Openings in the ceramic core-shell mold can be plugged or covered using, for example, wax, in preparation for the casting process. At least a portion of the ceramic core-shell mold or the plug can be coated with a second ceramic material.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic perspective view of an intermediate investment casting mold having a core and shell in accordance with an exemplary embodiment of the present disclosure.

FIG. 2 is a cross-section taken along line II-II of FIG. 1 in accordance with an exemplary embodiment of the present disclosure.

FIG. 3 is the intermediate investment casting mold of FIG. 2 with a second shell, defining an investment casting mold in accordance with an exemplary embodiment of the present disclosure.

FIG. 4 is a variation of the intermediate investment casting mold of FIG. 1 in accordance with an exemplary embodiment of the present disclosure.

FIG. 5 is a schematic cross-section illustrating various cross sections of anchors for the intermediate investment casting mold of FIG. 1 or FIG. 4 in accordance with an exemplary embodiment of the present disclosure.

FIG. 6 is a flow chart illustrating a method of forming the investment casting mold of FIG. 3 in accordance with an exemplary embodiment of the present disclosure.

FIG. 7A illustrates the investment casting mold forming a cast component in accordance with an exemplary embodiment of the present disclosure.

FIG. 7B illustrates the cast component from 7A in accordance with an exemplary embodiment of the present disclosure.

### DETAILED DESCRIPTION

Aspects of the disclosure herein are directed to an investment casting mold having an intermediate investment casting mold that includes a core and a first shell. The core and the first shell can be integrally formed, for example, by additive manufacturing. Optionally, one or more linking structures are formed between the core and the first shell. Optionally, portions of the core, first shell, or regions between the core and shell can be plugged, for example, using wax. A second shell or overshell can be applied to portions of the core, first shell, or plugs. The second shell can be applied by dipping portions of the core, first shell, or plugs into a liquid material. Additionally, or alternatively, the second shell can be applied via brush, spray, or other known method of application. The second shell and the first shell can be made of different ceramics. Anchors can emanate from the first shell or core. The anchors are protrusions or recesses that can couple, fasten, lock, or otherwise secure the core or first shell to the second shell.

Reference will now be made in detail to an investment casting mold where the first shell includes a first ceramic and the second shell includes a second ceramic, however, any investment casting mold where the core or first shell include a different material than the second shell applied or coupled to the core or first shell are considered. The detailed description uses numerical and letter designations to refer to features in the drawings.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

As used herein, the term “upstream” refers to a direction that is opposite the fluid flow direction, and the term “downstream” refers to a direction that is in the same direction as the fluid flow. The term “fore” or “forward” means in front of something and “aft” or “rearward” means behind something. For example, when used in terms of fluid flow, fore/forward can mean upstream and aft/rearward can mean downstream.

The term “fluid” may be a gas or a liquid, or multi-phase. The term “fluid communication” means that a fluid is capable of making the connection between the areas specified.

Additionally, as used herein, the term “radial” refers to a direction away from a common center. For example, in the overall context of a turbine engine, radial refers to a direction along a ray extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, connected, and joined) are to be construed broadly and can include intermediate structural elements between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

The singular forms “a”, “an”, and “the” include plural references unless the context clearly dictates otherwise. Furthermore, as used herein, the term “set” or a “set” of elements can be any number of elements, including only one.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, “generally”, and “substantially”, are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “additive manufacturing” generally refers to manufacturing processes wherein successive layers of material(s) are provided on each other to “build-up,” layer-by-layer, a three-dimensional component. The successive layers generally fuse together to form a monolithic unitary component, which can have a variety of integral sub-components. Monolithic, as used herein, refers to a unitary structure lacking interfaces or joints by virtue of the materials of each layer fusing to or melting with the materials of adjacent layers such that the individual layers lose their identity in the final unitary structure.

Suitable additive manufacturing techniques in accordance with the present disclosure include, for example, Directed Energy Deposition (DED), Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

In addition to using a direct metal laser sintering (DMLS) or direct metal laser melting (DMLM) process where an energy source is used to selectively sinter or melt portions of a layer of powder, it should be appreciated that according to alternative aspects of the present disclosure, the additive manufacturing process can be a “binder jetting” process. In this regard, binder jetting involves successively depositing layers of additive powder in a similar manner as described above. However, instead of using an energy source to generate an energy beam to selectively melt or fuse the additive powders, binder jetting involves selectively depositing a liquid binding agent onto each layer of powder. The liquid binding agent can be, for example, a photo-curable polymer or another liquid bonding agent. Other suitable additive manufacturing methods and variants are intended to be within the scope of the present subject matter.

The term “investment casting mold” as used herein generally relates to a mold that receives a liquid that later solidifies into a component. The liquid can be a molten metal or combination of various materials.

As used herein, the term “emanate” means to proceed from a source. In other words, the term “emanates” includes extending away from a surface or recessed into a surface. For example, a canyon, recess, or hole can emanate from the surface of the Earth. That is, the canyon, recess, or hole begins at the surface of the Earth and proceeds or recesses into the Earth. Similarly, a hill or mountain can emanate from the surface of the Earth. That is, the hill or mountain begins at the surface of the Earth and proceeds or extends away from the surface of the Earth.

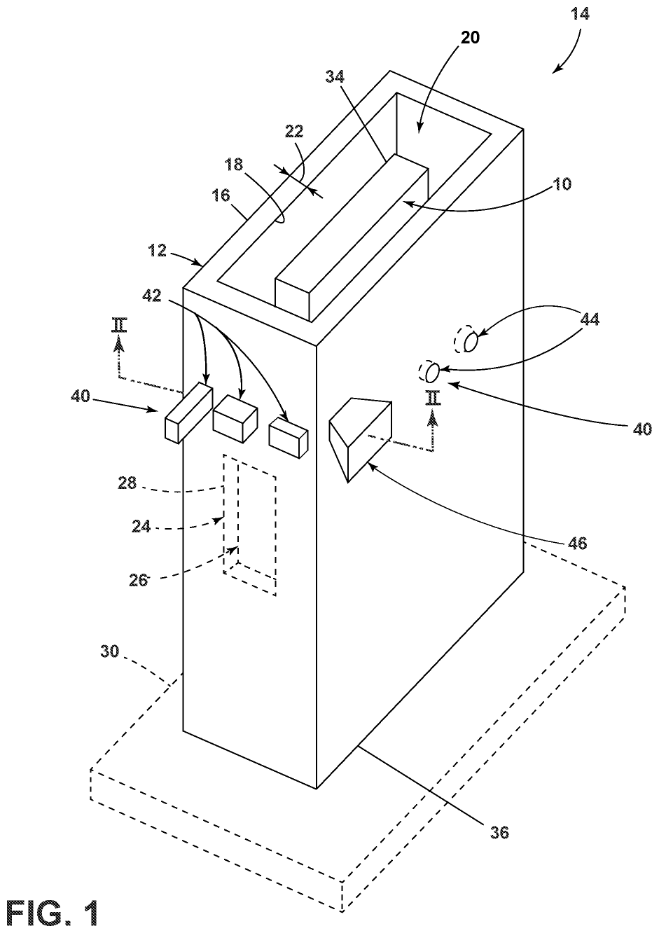

FIG. 1 illustrates an intermediate investment casting mold 14 having a core 10 and a first shell 12, which, at least, partially surrounds the core 10. The core 10 and the first shell 12 can be integrally formed. As used herein, the term “integrally formed” generally refers component or parts that are unitarily formed or are welded or otherwise secured together. That is, the core 10 and the first shell 12 can be unitarily formed with one or more linking portions between the core 10 and the first shell 12. It is contemplated that the core 10 and the first shell 12 can be additively manufactured such that the one or more linking portions are formed with the core 10 and the first shell 12 during the additive manufacturing process. Additionally, or alternatively, one or more linking portions can secure the core 10 to one or more portions of the first shell 12.

The first shell 12 includes an outer surface 16 and an inner surface 18, with the inner surface 18 defining an interior 20 in which at least a portion of the core 10 is located. While illustrated as a hollow rectangular prism, any shape or combination of shapes is contemplated for the first shell 12, where that shape can define an interior. For example, a hollow prism having a cross section that is a circle, oval, ellipse, square, or any regular or irregular polygon. By way of further non-limiting example, inner surface 18 can be a complimentary shape of an exterior of a component for a turbine engine. The hollow rectangular prism is used for ease of description and explanation. The shape of the inner surface 18 and the core 10 can be dictated by the shape of the part being cast.

A thickness 22 of the first shell 12 is defined by the distance between the inner surface 18 and the outer surface 16. While illustrated as uniform, it is contemplated that the thickness 22 of the first shell 12 can vary.

Optionally, at least one aperture or a window 24 can be included in the first shell 12. The window 24 can be any shaped through opening, hole, or passage that extends from the outer surface 16 to the inner surface 18 of the first shell 12. That is, the window 24 can pass through the thickness 22 of the first shell 12. A window passage 26 can be defined by at least one window wall 28 extending from the outer surface 16 to the inner surface 18 of the first shell 12. Any number of windows 24 in the first shell 12 are contemplated.

Optionally, a mold base 30 can support at least a portion of the first shell 12 or the core 10. That is, the first shell 12 or the core 10 can extend from the mold base 30. It is contemplated that the mold base 30 can be additively manufactured with or otherwise coupled to the first shell 12 and the core 10, forming one or more linking portions between the core 10 and the first shell 12. That is, the mold base 30 can couple a lower portion of the core 10 to a lower shell portion 36. It is further contemplated that the mold base 30 can be machined or at least partially removed from the first shell 12 or the core 10.

The core 10 is located within the interior 20 of the first shell 12 and spaced, at least in part, from the inner surface 18 of the first shell 12. The core 10 can have an outer core surface 34 that is at least partially spaced from and faces the inner surface 18 of the first shell 12. While illustrated as a rectangular prism, any shape or combination of shapes is contemplated that can be contained in the interior. For example, a prism having a cross section that is a circle, oval, ellipse, square, or any regular or irregular polygon. By way of further non-limiting example, the core 10 or a portion of the outer core surface 34 can be a complimentary shape of an interior portion of a component for a turbine engine. It is contemplated that the core 10 can include one or more recesses, apertures, passages, or protrusions (not shown).

A plurality of anchors 40 can emanate from the outer surface 16 of the first shell 12. While illustrated as emanating from the outer surface 16, it is contemplated that one or more of the plurality of anchors 40 can emanate from the inner surface 18, the core 10, or the outer core surface 34. A local tangential plane can be defined by the outer surface 16, the inner surface 18, the core 10, or the outer core surface 34 at the intersection of the outer surface 16, the inner surface 18, the core 10, or the outer core surface 34 for each of the plurality of anchors 40. One or more of the plurality of anchors 40 emanating from the local tangential plane, respective to the one or more of the plurality of anchors 40 can form a negative draft angle relative to a plane or line drawn normal to the relative local tangential plane. Alternatively, one or more of the plurality of anchors 40 can form a zero draft angle or a positive draft angle.

A first subset 42 of the plurality of anchors 40 emanating from the outer surface 16 of the first shell 12 can protrude or otherwise extend away from the outer surface 16. That is, the first subset 42 can be positive surface features. The first subset 42 are illustrated, by way of example, as rectangular prisms having a rectangular cross section, however any shape cross section that would protrude from of extend away from the outer surface 16 is contemplated. Examples of possible cross-sectional profiles for the first subset 42 can include, but are not limited to, one or more of a trapezoid, rectangle, triangle, chevron, circle, mushroom, arc, or T-shape.

A second subset 44 of the plurality of anchors 40 emanating from the outer surface 16 can recess or extend into the first shell 12 from the outer surface 16. That is, the second subset 44 can be negative surface features.

A third subset 46 of the plurality of anchors 40 and emanating from the outer surface 16 illustrates a variety of possible shapes and changing dimensions possible for the plurality of anchors 40.

The first subset 42, the second subset 44, and the third subset 46 can be defined as point anchors. That is, the first subset 42, the second subset 44, and the third subset 46 include anchors where each anchor is discrete or separate from another. That is, there can be a horizontal or a vertical separation of at least 0.25 micrometers between two or more anchors of the plurality of anchors 40.

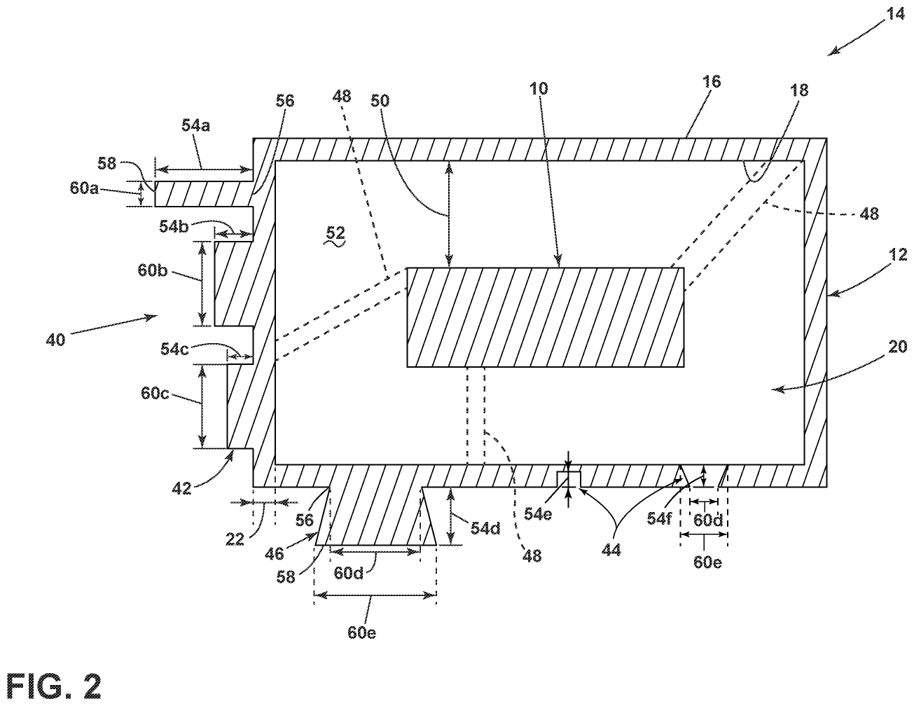

FIG. 2 is a cross section taken at line II-II of FIG. 1 and illustrates the details of the plurality of anchors 40 along with the spatial relationships between the core 10, the first shell 12, and the plurality of anchors 40 of the intermediate investment casting mold 14. Various spatial relationships and dimensions between the core 10, first shell 12 and anchors 40 are useful for a complete understanding of the intermediate investment casting mold 14.

Optionally, at least one connecting structure 48 can extend between the core to the first shell 12. The at least one connecting structure 48 can be formed with core 10 and the first shell 12. While illustrated as a having a cross-sectional shape that is generally rectangular, any cross-sectional shape is considered. It is contemplated that the at least one connecting structure 48 can change cross-sectional area. It is also contemplated that the at least one connecting structure 48 can extend from any portion of the core 10 to another portion of the first shell 12 in a non-linear manner. That is, the at least one connecting structure 48 can be linear, curved, or any combination therein. Additionally, it is contemplated that the at least one connecting structure 48 can be angled horizontally, vertically, or a combination of horizontally and vertically relative to the mold base 30, the inner surface 18 of the first shell 12 or the outer core surface 34.

A void 52 is defined by the space between the core 10 and the inner surface 18. It is contemplated that the void 52 can be filled with air. The void 52 can be filled with air during the additive manufacturing of the core 10 and the first shell 12. Additionally, or alternatively, prior to coating at least a portion of the first shell 12 (described presently), the void 52 can be filled with wax. It is further contemplated that the void 52, during casting, can be filled with molten material that will harden into a component.

A core distance 50 can be defined as the distance between the core 10 and the inner surface 18. It is contemplated that the core distance 50 can change from one portion of the intermediate investment casting mold 14 to another.

The cross-sectional profile of the first subset 42 of the plurality of anchors 40 is a rectangle, by way of non-limiting example. The third subset 46 of the plurality of anchors 40 has a cross-sectional profile in the shape of a trapezoid. The second subset 44 of the plurality of anchors 40 illustrates anchors with both a rectangular cross section and a trapezoidal cross section. That is, anchors within the same subset can have different sized or shaped cross sections.

An extension dimension can be measured for each of the plurality of anchors 40. The extension dimension can be measured from a surface from which the anchor 40 emanates to the farthest emanating point of the anchor 40 from the surface. As illustrated, by way of example, extension dimensions 54a, 54b, 54c for the first subset 42 of the plurality of anchors 40 can be measured from the outer surface 16 to the point farthest from the inner surface 18, as the first subset 42 extend away from the outer surface 16. The extension dimension 54a, 54b, 54c can be measured normal to or generally perpendicular to the outer surface 16 from a base 56 on the outer surface 16 to a tip 58 of each of the anchors 40 of the first subset 42. It is contemplated that the extension dimensions 54a, 54b, 54c can change from one anchor to another. That is, at least two of the anchors 40 of the first subset 42 can have different values for the extension dimension 54a, 54b, 54c. As illustrated by way of example, each anchor 40 of the first subset 42 has a different extension dimension 54a, 54b, 54c value.

The third subset 46 of the plurality of anchors 40 can include an extension dimension 54d equal to or different from the extension dimensions 54a, 54b, 54c of the first subset 42.

For anchors such as the first subset 42 or the third subset 46 that extend away from the outer surface 16, the one or more of the extension dimensions 54a, 54b, 54c, 54d can be less than or equal to the thickness 22 of the first shell 12. Additionally, or alternatively, one or more of the extension dimensions 54a, 54b, 54c, 54d can be greater that the thickness 22. It is contemplated that the extension dimension 54a, 54b, 54c, 54d for anchors 40 that extend away or protrude from the outer surface 16 can be between or equal to 10%-500% of the thickness 22 of the first shell 12. It is further contemplated that the extension dimensions 54a, 54b, 54c, 54d can be between or equal to 20%-300% of the thickness 22. It is yet further contemplated that the extension dimensions 54a, 54b, 54c, 54d can be between or equal to 20%-200% of the thickness 22.

For anchors 40 such as the second subset 44 of the plurality of anchors 40 that extend into the first shell 12 from the outer surface 16 toward the inner surface 18, the extension dimension 54e, 54f is less than the thickness 22 of the first shell 12. It is contemplated that the extension dimensions 54e, 54f for anchors 40 that extend into or form recesses in the first shell 12 can be between or equal to 5%-85% of the thickness 22 of the first shell 12. It is further contemplated that the extension dimension 54e, 54f can be between or equal to 15%-65% of the thickness 22.

A cross dimension can be measured along or generally parallel to the surface from which each anchor 40 of the plurality of anchor 40 emanates. The cross dimension can be measured at any point between the base 56 and the tip 58 of each of the anchors 40 of the plurality of anchors 40.

The cross dimension for each of the first subset 42 of the plurality of anchors 40 does not change as each of the anchors 40 extends from the base 56 to the tip 58. The cross dimension of each anchor of the first subset 42 are illustrated, by way of example, as cross dimensions 60a, 60b, 60c. It is contemplated that the cross dimensions 60a, 60b, 60c can change from one anchor to another. That is, at least two of the anchors 40 of the first subset 42 can have equal values or different values for the cross dimension 60a, 60b, 60c.

As illustrated, by way of example, at least one of the second subset 44 or the third subset 46 of the plurality of anchors 40 can include at least one anchor 40 having a first cross dimension 60d and a second cross dimension 60e. The first cross section dimension 60d can be measured at the outer surface 16 or the base 56 of the anchor 40. The second cross dimension 60e can be measured away from the outer surface 16, for example, at the tip 58 of the anchor 40. As illustrated, by way of example, the first cross dimension 60d can be less than the second cross dimension 60e. Alternatively, the first cross section dimension 60d can be greater than the second cross dimension 60e.

It is contemplated that the ratio of the first cross dimension 60d to the second cross dimension 60e can be equal to or between 1:4 and 4:1. The first subset 42 illustrates, by way of example, anchors 40 having an equal first cross dimension and second cross dimension.

It is contemplated that the cross dimension 60a, 60b, 60c, 60d, 60e of the plurality of anchors 40 can be between or equal to 5% and 1000% of the thickness 22 of the first shell 12. It is further contemplated that the cross dimension 60 can be between or equal to 15%-500% of the thickness 22.

As illustrated, the extension dimension 54a, 54b, 54c, 54d, 54e, 54f can be greater than, equal to, or less than the cross dimension 60a, 60b, 60c, 60d, 60e. It is contemplated that the ratio of the extension dimension 54a, 54b, 54c, 54d, 54e, 54f to the cross dimension 60a, 60b, 60c, 60d, 60e can be between or equal to 1:15 and 15:1. It is further contemplated that the ratio of the extension dimension 54a, 54b, 54c, 54d, 54e, 54f to the cross dimension 60a, 60b, 60c, 60d, 60e can be between or equal to 1:8 and 8:1.

A shell volume can be defined as the volume of the first shell 12 without the plurality of anchors 40. An anchor volume can be defined as the volume of the plurality of anchors 40. The anchor volume can be the volume of the anchors that extend from the first shell 12 or the core 10 plus the volume of one or more voids defined by anchors 40 that extend into the first shell 12 or the core 10. By way of non-limiting example, if the volume of the subset of anchors that extend from the first shell 12 or the core 10 is a total of seven cubic millimeters and the volume of one or more voids defined by the anchors 40 that extend into the first shell 12 or the core 10 is a total of four cubic centimeters, the anchor volume would be eleven cubic centimeters.

Alternatively, the anchor volume can be the subtraction of the volume of one or more voids defined by anchors 40 that extend into the first shell 12 or the core 10 from the subset of anchors 40 that extend from the first shell 12 or the core 10. That is, by way of non-limiting example, if the volume of the subset of anchors 40 that extend from the first shell 12 or the core 10 is a total of seven cubic millimeters and the volume of one or more voids defined by anchors 40 that extend into the first shell 12 or the core 10 is a total of four cubic centimeters, the anchor volume would be three cubic centimeters. It is contemplated that the anchor volume is between 1% to 50% of the shell volume. It is further contemplated that the anchor volume is between 2% to 35% of the shell volume.

A core-shell volume can be the volume of the core 10 and the first shell 12 without the plurality of anchors 40. Optionally, the anchor volume is between 0.2% to 50% of the core-shell volume. It is further contemplated that the anchor volume is between 1% to 20% of the shell volume.

A shell material volume is the amount of material needed to create the first shell 12 prior to the addition of the anchors 40 to the design. A positive anchor volume is the volume of material added to form anchors 40 that extend from or protrude from the first shell 12. A negative anchor volume is the volume of material that is removed by the forming of a void defined by anchors 40 that extend into the first shell 12. A total volume can be the shell material volume plus the positive anchor volume minus the negative anchor volume. The total volume can be −50% to 300% of the shell material volume.

A core-shell material volume is the amount of material needed to create the core 10 and the first shell 12 prior to the addition of the anchors 40 to the design. A positive anchor volume is the volume of material added to form anchors 40 that extend from or protrude from the core 10 or the first shell 12. A negative anchor volume is the volume of material that is removed by the forming of a void defined by anchors 40 that extend into the core 10 or the first shell 12. A total volume can be the core-shell material volume plus the positive anchor volume minus the negative anchor volume. The total volume can be −25% to 150% of the core-shell material volume.

A shell surface area can be determined by measuring or calculating the surface area of the outer surface 16 of the first shell 12. The shell surface area ignores or neglects the presence of the plurality of anchors 40. An anchor surface area can be determined by measuring or calculating the surface area of the plurality of anchors 40. It is contemplated the anchor surface area is 2%-200% of the shell surface area. It is further contemplated the anchor surface area is 5%-140% of the shell surface area.

A core-shell surface area can be addition of the surface area of the outer surface 16, the surface area of the inner surface 18, and the surface area of the outer core surface 34. It is contemplated the anchor surface area is 0.5%-300% of the core-shell surface area. It is further contemplated the anchor surface area is 3%-200% of the core-shell surface area.

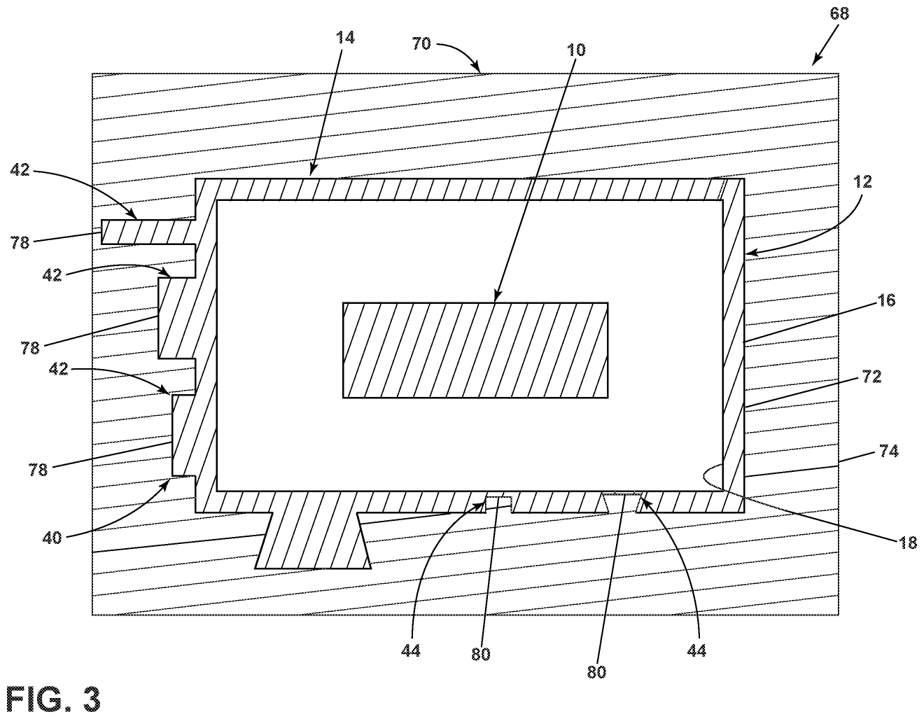

FIG. 3 illustrates the intermediate investment casting mold 14 of FIG. 2 further comprising an overcoat, an overshell, or a second shell 70. An investment casting mold 68 can be defined by the intermediate investment casting mold 14 and the second shell 70. The location of the plurality of anchors 40 can correspond to the location of the second shell 70. That is, the second shell 70 can coat, cover, or fill the plurality of anchors 40. The second shell 70 can encapsulate the first shell 12 and core 10. Optionally, prior to applying the second shell 70, wax (not shown) can be used to fill or seal one or more of the window 24 (FIG. 1) or void 52 (FIG. 2). The second shell 70 can establishes pathways for metal flow during casting. The second shell 70 can have an inner second shell surface 72 and an outer second shell surface 74. The inner second shell surface 72 can be in direct contact with at least a portion of the outer surface 16 of first shell 12.

The core 10 and the first shell 12 can be made of a first ceramic material. Optionally, the core 10 and the first shell 12 can be additively manufactured using at least the first ceramic material. The first ceramic material can include, for example, one or more of aluminum nitride, zirconia, silicon nitride, silicon carbide, alumina, zircon, silica, or yttria, however any ceramic or ceramic composition is contemplated. It is contemplated that the core 10 and the first shell 12 can be include different ceramic material. It is further contemplated that the ceramic composition can be different from one portion of the first shell 12 or the core 10 to another.

The second shell 70 is formed by the layering of second shell slurries that can include a second ceramic material. The second shell slurry or second ceramic material can include, for example, colloidal silica and a ceramic powder such as, but not limited to, one or more of aluminum oxide, silicon dioxide, zirconium silicate, zirconium dioxide, yttrium oxide, aluminum nitride, or silicon carbide.

The second ceramic material used to form the second shell 70 is different from the first ceramic material used to additively manufacture at least the first shell 12 or the core 10. That is, the first ceramic material and the second ceramic material can have, for example, different micro-structures, compounds, elements, or density. Although the first shell 12 and the second shell 70 are both ceramic, the property differences between the first ceramic material and the second ceramic material can cause separation during casting. That is, at casting temperatures, the first ceramic material and second ceramic material can separate.

The plurality of anchors 40 that emanate from the first shell 12 receive a portion or extend into a portion of the second shell 70 to prevent separation between the first shell 12 and the second shell 70 during casting. That is, the plurality of anchors 40 interlock, interlace, engage, interlink, anchor, secure or otherwise couple the first shell 12 and the second shell 70.

Optionally, if second shell 70 is added to the inner surface 18 or the core 10, anchors 40 can be added to couple the inner surface 18 or the core 10 to the second shell 70.

The plurality of anchors 40 coupling the second shell 70 to first shell 12 includes a negative feature in one of the second shell 70 or first shell 12, and a positive feature in the other of the second shell 70 or first shell 12, wherein the negative and positive features are complementary. For example, the first subset 42 of the plurality of anchors 40 provide positive features extending from the first shell 12. The second shell 70 has complimentary anchor features illustrated as negative features 78 complimentary to the first subset 42. By further non-limiting example, the second subset 44 of the plurality of anchors 40 provides negative features extending into the first shell 12. The second shell 70 includes additional complimentary anchor features illustrated as positive features 80 complimentary to the second subset 44.

While illustrated as the first shell 12 and the second shell 70, any number of shells are contemplated. By way of non-limiting example, an additional shell, additional shells, or other coating materials can be added to portions of the first shell 12 or the core 10. It is contemplated that at least a subset of the plurality of anchors 40 can interface, interlock, or otherwise couple the first shell 12 or the core 10 to the additional shell, the additional shells, or the other coating materials. If is further contemplated that the additional shell, the additional shells, or the other coating materials can be applied to the outer second shell surface 74, wherein at least a subset of the plurality of anchors 40 emanates through or within the second shell 70 and interfaces, interlocks, or otherwise couples the second shell to the additional shell, the additional shells, or the other coating materials.

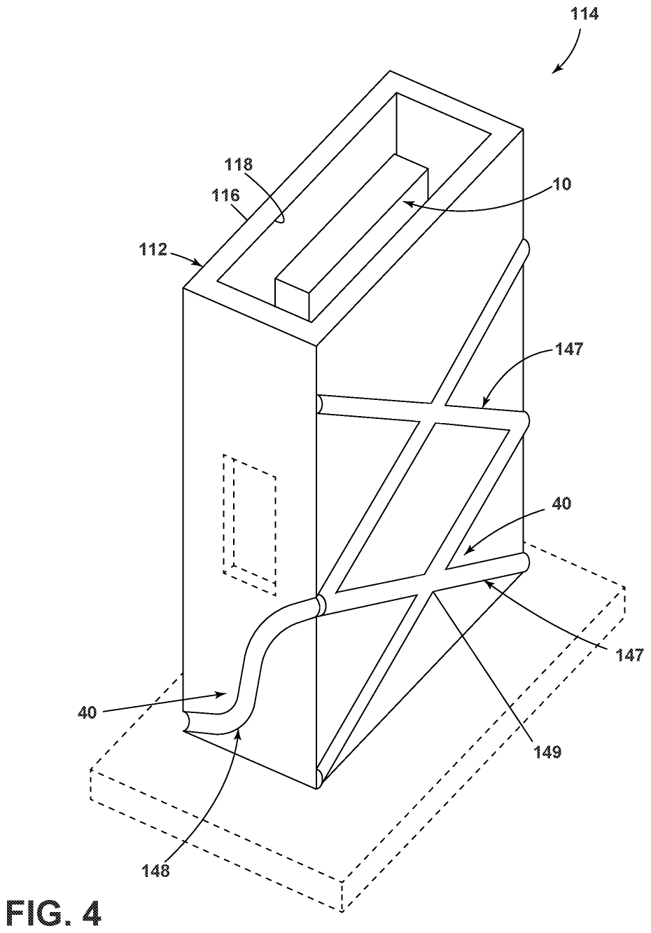

FIG. 4 illustrates an intermediate investment casting mold 114 having the core 10 and a first shell 112, which, at least, partially surrounds the core 10. The first shell 112 includes an outer surface 116 and an inner surface 118. A fourth subset 147 of the plurality of anchors 40 is illustrated, by example, as linear anchors. The fourth subset 147 can include multiple linear anchors in predetermined arrangements, including arrangements of two or more linear anchors that intersect to form one or more intersection points 149. The linear anchors or fourth subset 147 of the plurality of anchors 40 can include intersecting and/or non-intersecting arrangements. Intersecting arrangements include: grid, lattice, or matrix. That is, any subset of intersecting anchors can form a grid, lattice, or matrix. While illustrated as positive features or extending from the outer surface 116, it is contemplated that one or more anchors of the fourth subset 147 can recess to extend into the outer surface 116.

A fifth subset 148 of the plurality of anchors 40 illustrates a non-linear anchor. While illustrated as a single non-linear anchor, any number of non-linear anchors are contemplated. It is further contemplated that the non-linear anchors or fifth subset 148 of the plurality of anchors 40 can intersect or not intersect to form uniform or non-uniform arrangements of anchors. While illustrated as a negative feature or extending into the outer surface 116, it is contemplated that one or more anchors of the fifth subset 148 can recess to extend away from the outer surface 116.

While illustrated as having the first subset 42, second subset 44, third subset 46, fourth subset 147, and the fifth subset 148 of the plurality of anchors 40, the first shell 12, 112 or core 10 can include any number of subsets or anchors; including one. That is, the plurality of anchors 40 can include at least one or any combination of a linear anchor, non-linear anchor, or point anchor. The different anchors described herein can be mixed and matched as desired to define the plurality of anchors 40.

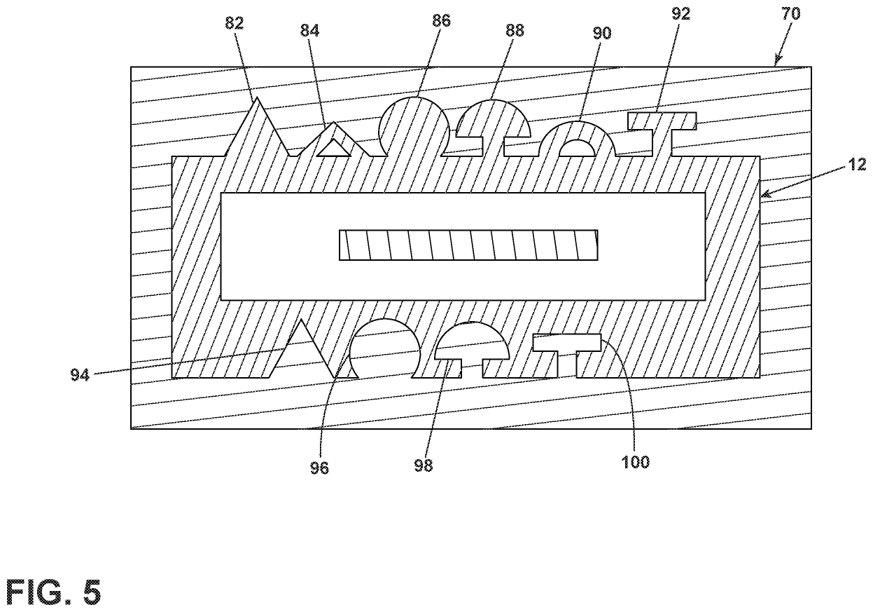

FIG. 5 illustrates alternative cross-sectional profiles of the plurality of anchors 40. The plurality of anchors 40 are illustrated as coated by or interlocked with the second shell 70.

The plurality of anchors 40, including the first subset 42, the second subset 44, the third subset 46, the fourth subset 147, or the fifth subset 148, can have a cross-sectional profile in the shape of at least one of a trapezoid, rectangle, triangle, chevron, circle, mushroom, arc, or T-shape. The cross-sectional profile of the plurality of anchors 40 can change from one shape to another from anchor to anchor or within a single anchor. Any cross section having a polygon shape, at least one curved portion, an irregular shape, or a shape that is the result of combined shapes is contemplated.

Optionally, the plurality of anchors 40 emanating from the first shell 12, 112 can have a positive feature, where the positive feature can be, for example, a positive triangular anchor 82, a positive chevron anchor 84, a positive circle anchor 86, a positive mushroom anchor 88, a positive arc anchor 90, or a positive T-shape anchor 92. Additionally, or alternatively, the plurality of anchors 40 recessed or extending into the first shell 12, 112 can include a negative feature such as a negative triangular anchor 94, a negative circle anchor 96, a negative mushroom anchor 98, or a negative T-shape anchor 100.

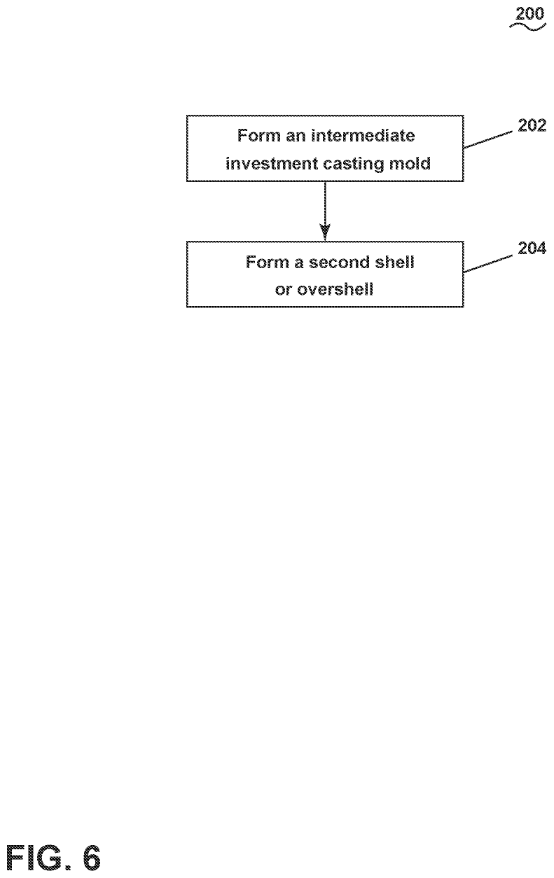

FIG. 6 is a method 200 of forming an investment casting mold 68. The method 200 includes, at 202, forming a shell-core mold or intermediate investment casting mold 14, 114. The intermediate investment casting mold 14, 114 can be formed from the first ceramic material, for example, via additive manufacturing. At least one anchor feature or the plurality of anchors 40 can be formed as at least one of a negative or a positive anchor feature on at least one of the first shell 12, 112 or the core 10 of the intermediate investment casting mold 14, 114. The negative feature can be formed in the outer surface 16, 116 of the first shell 12, 112, the inner surface 18, 118 of the first shell 12, 112, or the core 10. The positive feature can extend from the outer surface 16, 116 of the first shell 12, 112, the inner surface 18, 118 of the first shell 12, 112, or the core 10. The plurality of anchors 40 formed on the first shell 12, 112 or core 10 can increase the surface area of the first shell 12, 112 or core to a total surface area that includes the surface area of the first shell 12, 112 and the plurality of anchors 40, where the total surface area is greater than the surface area of the first shell 12, 112 and the core 10 without the plurality of anchors 40.

Optionally, after forming the plurality of anchors 40, the plurality of anchors 40 can be sanded, machined, or otherwise shaped. The shaping can further increase the total surface area.

Optionally, wax can be added to the intermediate investment casting mold 14, 114. Wax or other leachable material can be used to fill at least a portion of the window 24 or the void 52.

At 204, the overshell or the second shell 70 can be formed on at least one of the first shell 12, 112 or core 10, by dipping the intermediate investment casting mold 14, 114 into a slurry and letting the slurry harden, dry, or otherwise solidify. The second shell 70 can be formed by layering of or by repeatedly dipping the intermediate investment casting mold 14, 114 in a liquid bath. The slurry can include at least a second ceramic material. The second shell slurry or second ceramic material can include, for example, colloidal silica and a ceramic powder, such as, but not limited to, one or more of aluminum oxide, silicon dioxide, zirconium silicate, zirconium dioxide, yttrium oxide, aluminum nitride, or silicon carbide.

The slurry can flow into the negative feature or around the positive feature to form a complimentary anchor feature 78, 80, which is complementary to the plurality of anchors 40. The complimentary anchor features 78, 80 formed by the second shell 70 and the plurality of anchors 40 secure the second shell 70 to the intermediate investment casting mold 14, 114.

Optionally, once the second shell 70 is formed, the second shell 70 is sanded, machined, or otherwise shaped. It is also contemplated that the investment casting mold 68, following forming the second shell 70, can be leached. The leaching process can remove wax or other materials from the investment casting mold 68.

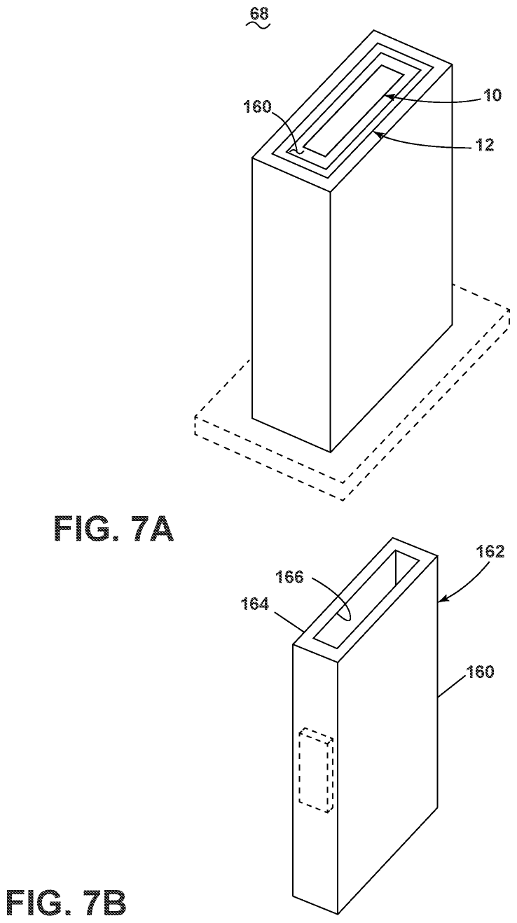

FIG. 7A illustrates the investment casting mold 68 during investment casting, wherein a metal 160 in the form of molten metal is provided between the core 10 and the first shell 12 or the first shell 112 (FIG. 4) of the investment casting mold 68. The molten metal 160 can be a superalloy such as, but not limited to any one or more of stainless steel, aluminum, titanium, cobalt chrome, nickel, among other metal materials or any alloy; such as nickel (Ni) superalloys, and/or Ni superalloy single crystal alloys. The molten metal 160 can then be cooled and demolded from the investment casting mold 68 to define a cast component 162 (see FIG. 7B).

FIG. 7B illustrates an example of the cast component 162 formed from the solidification of the molten metal 160. The cast component 162 can have an exterior surface 164 and an interior surface 166. The exterior surface 164 can be a complimentary shape to the inner surface 18, 118 of the first shell 12, 112 (see FIG. 1 and FIG. 4). The interior surface 166 of the cast component 162 can be a complimentary shape to the outer core surface 34 of the core 10 (see FIG. 1).

Benefits associated with the investment casting mold as described herein include the plurality of anchors that couple the first shell and the second shell. The plurality of anchors increases the surface area in contact between the first shell and second shell.

The shape of the anchors can provide a locking feature between the first shell and the second shell.

Positive and/or negative anchors can extend from or recess into the shell. While increasing the surface area, the overall amount of material required to print the shell is minimally increased or decreased.

The intermediate investment casting mold (core and first shell) and the second shell are comprised of different ceramics. When the second shell is applied to the core or the first shell, the plurality of anchors located at the first shell or the core reduce separation between the two materials. That is, the plurality of anchors increases the surface area between and secures the intermediate investment casting mold to the second shell.

When molten metal is added to the investment casting mold, the high temperatures can cause a first material to change differently than a second material with a slightly different chemical make-up. The shell-core is printed in a first material, while the second shell is a second material. When the molten metal is added to cast a part, the increased surface area between the first shell and the second shell from the plurality of anchors secures the two materials together when encountering molten metal or other high temperature material.

Another benefit is the plurality of anchors coupling the second shell to the first shell. The anchors can include a negative feature or a positive feature in one of the core or the first shell, and a negative feature or a positive feature in the second shell, wherein the negative and positive features are complementary. The complimentary features of the first shell or core and the second shell secure or interlock the first shell or core and the second shell.

Further aspects of the disclosure are provided by the subject matter of the following clauses:

An intermediate investment casting mold comprising a shell having an outer surface and an inner surface, with the inner surface defining an interior of the shell, a core located within the interior and spaced from the inner surface, at least in part, to define a void between the core and the inner surface, and a plurality of anchors emanating from the outer surface, wherein each of the plurality of anchors includes an extension dimension and a cross dimension, wherein for at least some of the plurality of anchors a ratio of the extension dimension to the cross dimension is equal to or between 1:8 and 8:1.

An intermediate investment casting mold comprising a shell having an outer surface and an inner surface, with the inner surface defining an interior of the shell, a core located within the interior and spaced from the inner surface, at least in part, to define a void between the core and the inner surface, and a plurality of anchors emanating from the outer surface, wherein an anchor volume is 1% to 50% of a shell volume.

An intermediate investment casting mold comprising a shell having an outer surface and an inner surface, with the inner surface defining an interior of the shell, a core located within the interior and spaced from the inner surface, at least in part, to define a void between the core and the inner surface, and a plurality of anchors emanating from the outer surface, wherein an anchor volume is 0.2% to 50% of a core-shell volume.

An intermediate investment casting mold comprising a shell having an outer surface and an inner surface, with the inner surface defining an interior of the shell, a core located within the interior and spaced from the inner surface, at least in part, to define a void between the core and the inner surface, and a plurality of anchors emanating from the outer surface, wherein an anchor surface area is 2%-200% of a shell surface area.

An intermediate investment casting mold comprising a shell having an outer surface and an inner surface, with the inner surface defining an interior of the shell, a core located within the interior and spaced from the inner surface, at least in part, to define a void between the core and the inner surface, and a plurality of anchors emanating from the outer surface, wherein an anchor surface area is 0.5%-300% of a core-shell surface area.

An intermediate investment casting mold comprising a first shell having a first shell outer surface and a first shell inner surface, with the first shell inner surface defining an interior for the first shell, a core located within the interior and spaced from the first shell inner surface, at least in part, to define a void between the core and the first shell inner surface, a second shell overlying at least a portion of the first shell, the second shell having a second shell outer surface and a second shell inner surface, which confronts the first shell outer surface, and a plurality of anchors coupling the second shell and the first shell, with the anchors comprising a negative feature in one of the first shell or the second shell, and a positive feature in the other of the first shell or second shell, wherein the negative and positive features are complementary.

An intermediate investment casting mold comprising a first shell having a first shell outer surface and a first shell inner surface, with the first shell inner surface defining an interior for the first shell, a core having a core outer surface and located within the interior, with the core outer surface spaced from the first shell inner surface, at least in part, to define a void between the core outer surface and the first shell inner surface, a second shell overlying at least a portion of at least one of the first shell or core to define an interface between the second shell and at least one of the first shell or core, and a plurality of anchors coupling the interface.

A method of forming an intermediate investment casting mold comprising forming a shell-core mold or a first shell-core mold with a first anchor feature comprising at least one of a negative or positive anchor feature on at least one of the first shell or core, wherein the negative feature is formed in an outer surface of the first shell or core, and the positive feature extends from the outer surface of the first shell or core, and forming an overshell or a second shell on at least one of the first shell or core, by dipping the first shell-core into a liquid bath and letting the liquid bath harden, wherein the liquid bath flows into the negative feature or around the positive feature to form a second anchor feature, which is complementary to the first anchor feature, wherein the first and second anchor features form an anchor securing the second shell to the first shell-core.

The intermediate investment casting mold of the preceding clause, wherein a thickness of the shell is defined by a distance between the inner surface and the outer surface.

The intermediate investment casting mold of any of the preceding clauses, wherein at least a subset of the plurality of anchors extend into the shell.

The intermediate investment casting mold of any of the preceding clauses, wherein the extension dimension is equal to or between 5%-85% of the thickness of the shell.

The intermediate investment casting mold of any of the preceding clauses, wherein at least a first subset of the plurality of anchors extend away from the shell.

The intermediate investment casting mold of any of the preceding clauses, wherein the extension dimension is equal to or between 10%-500% of the thickness of the shell.

The intermediate investment casting mold of any of the preceding clauses, wherein a second subset of the plurality of anchors extend into the shell.

The intermediate investment casting mold of any of the preceding clauses, wherein the cross dimension includes a first cross dimension and a second cross dimension, a ratio between the first cross dimension and the second cross dimension equal to or between 1:4 and 4:1.

The intermediate investment casting mold of any of the preceding clauses, wherein at least a subset of the plurality of anchors have a first cross dimension, at the outer surface, and a second cross dimension away from the outer surface.

The intermediate investment casting mold of any of the preceding clauses, wherein the first cross dimension is less than the second cross dimension.

The intermediate investment casting mold of any of the preceding clauses, wherein the first cross dimension is greater than the second cross dimension.

The intermediate investment casting mold of any of the preceding clauses, wherein the extension dimension is greater than the first cross dimension.

The intermediate investment casting mold of any of the preceding clauses, wherein the extension dimension is less than the first cross dimension.

The intermediate investment casting mold of any of the preceding clauses, wherein the extension dimension is less than the second cross dimension.

The intermediate investment casting mold of any of the preceding clauses, wherein the extension dimension is greater than the second cross dimension.

The intermediate investment casting mold of any of the preceding clauses, wherein the plurality of anchors have a cross-sectional profile in the shape of at least one of a: trapezoid, rectangle, triangle, chevron, circle, mushroom, arc, or T-shape.

The intermediate investment casting mold of any of the preceding clauses, wherein the plurality of anchors comprise at least one of: linear anchors, non-linear anchors, or point anchors.

The intermediate investment casting mold of any of the preceding clauses, wherein at least a subset of the anchors intersect.

The intermediate investment casting mold of any of the preceding clauses, wherein the subset of intersecting anchors form at least one of a: grid, lattice, or matrix.

The intermediate investment casting mold of any of the preceding clauses, wherein the core and the shell are integrally formed.

The intermediate investment casting mold of any of the preceding clauses, wherein the shell is a first shell.

The intermediate investment casting mold of any of the preceding clauses, further comprising a second shell overlying at least a portion of the first shell.

The intermediate investment casting mold of any of the preceding clauses wherein the plurality of anchors couple the first shell and second shell.

The intermediate investment casting mold of any of the preceding clauses wherein the plurality of anchors comprise a negative feature in one of the first shell or the second shell, and a positive feature in the other of the first shell or the second shell, wherein the negative and positive features are complementary.

The intermediate investment casting mold of any of the preceding clauses wherein the plurality of anchors coupling the interface comprise a negative feature and a positive feature, wherein the negative and positive features are complementary.

The intermediate investment casting mold of any of the preceding clauses wherein at least a subset of the plurality of anchors are point anchors.

The intermediate investment casting mold of any of the preceding clauses wherein at least a subset of the plurality of anchors are linear or non-linear anchors.

The intermediate investment casting mold of any of the preceding clauses wherein the first shell or core is a ceramic or ceramic composition.

The intermediate investment casting mold of any of the preceding clauses wherein the first shell or core includes one or more of aluminum nitride, zirconia, silicon nitride, silicon carbide, alumina, zircon, silica, or yttria.

The intermediate investment casting mold of any of the preceding clauses wherein the second shell includes colloidal silica and a ceramic powder such as, but not limited to, one or more of aluminum oxide, silicon dioxide, zirconium silicate, zirconium dioxide, yttrium oxide, aluminum nitride, or silicon carbide.

The intermediate investment casting mold of any of the preceding clauses wherein a total volume is −50% to 300% of a shell material volume.

The intermediate investment casting mold of any of the preceding clauses wherein a total volume is −25% to 150% of a core-shell material volume.

1. An intermediate investment casting mold comprising:
a shell having an outer surface and an inner surface, with the inner surface defining an interior of the shell;
a core located within the interior and spaced from the inner surface, at least in part, to define a void between the core and the inner surface wherein the core and the shell are integrally formed;
at least one connecting structure extending between the core and the shell and formed with the core and the first shell; and
a plurality of anchors emanating from the outer surface, wherein each of the plurality of anchors includes an extension dimension and a cross dimension, wherein for at least some of the plurality of anchors a ratio of the extension dimension to the cross dimension is equal to or between 1:8 and 8:1.

2. The intermediate investment casting mold of claim 1, wherein a thickness of the shell is defined by a distance between the inner surface and the outer surface.

3. The intermediate investment casting mold of claim 2, wherein at least a subset of the plurality of anchors extend into the shell.

4. The intermediate investment casting mold of claim 3, wherein the extension dimension is equal to or between 5%-85% of the thickness of the shell.

5. The intermediate investment casting mold of claim 2, wherein at least a first subset of the plurality of anchors extend away from the shell.

6. The intermediate investment casting mold of claim 5, wherein the extension dimension is equal to or between 10%-500% of the thickness of the shell.

7. The intermediate investment casting mold of claim 5, wherein a second subset of the plurality of anchors extend into the shell.

8. The intermediate investment casting mold of claim 1, wherein the cross dimension includes a first cross dimension and a second cross dimension, a ratio between the first cross dimension and the second cross dimension equal to or between 1:4 and 4:1.

9. The intermediate investment casting mold of claim 1, wherein at least a subset of the plurality of anchors have a first cross dimension, at the outer surface, and a second cross dimension away from the outer surface.

10. The intermediate investment casting mold of claim 9, wherein the first cross dimension is less than the second cross dimension.

11. The intermediate investment casting mold of claim 9, wherein the first cross dimension is greater than the second cross dimension.

12. The intermediate investment casting mold of claim 11, wherein the extension dimension is greater than the first cross dimension.

13. The intermediate investment casting mold of claim 11, wherein the extension dimension is less than the first cross dimension.

14. The intermediate investment casting mold of claim 11, wherein the extension dimension is less than the second cross dimension.

15. The intermediate investment casting mold of claim 11, wherein the extension dimension is greater than the second cross dimension.

16. The intermediate investment casting mold of claim 1, wherein the plurality of anchors have a cross-sectional profile in the shape of at least one of a: trapezoid, rectangle, triangle, chevron, circle, mushroom, arc, or T-shape.

17. The intermediate investment casting mold of claim 16, wherein the plurality of anchors comprise at least one of: linear anchors, non-linear anchors, or point anchors.

18. The intermediate investment casting mold of claim 17, wherein at least a subset of the anchors intersect.

19. The intermediate investment casting mold of claim 18, wherein the subset of intersecting anchors form at least one of a: grid, lattice, or matrix.

20. (canceled)

21. The intermediate investment casting mold of claim 1, wherein the core and the shell are additively manufactured and integrally formed.
